(19) United States
(12) Patent Application Publication
(10) Pub. No.: US 2025/0001933 A1
(43) Pub. Date: Jan. 2, 2025

(54) DISPLAY CONTROL DEVICE AND DISPLAY CONTROL METHOD

(71) Applicant: Mitsubishi Electric Corporation, Tokyo (JP)

(72) Inventors: Takayasu HASHIMOTO, Tokyo (JP); Yuri KUBOTA, Tokyo (JP)

(73) Assignee: Mitsubishi Electric Corporation, Tokyo (JP)

(21) Appl. No.: 18/882,843

(22) Filed: Sep. 12, 2024

Related U.S. Application Data
(63) Continuation of application No. PCT/JP2022/015242, filed on Mar. 29, 2022.

(51) Int. Cl. B60Q 9/00; G06F 3/14

(52) U.S. Cl. CPC B60Q 9/00; G06F 3/14

(57) ABSTRACT

A display control device includes processing circuitry configured to acquire occupant information regarding an occupant; acquire operation information regarding an operation of a vehicle by a driver of the vehicle; determine progress of preparation by a passenger for departure of the vehicle; determine intention to cause the vehicle to depart by the driver; determine a plurality of levels for warning the driver of severity of an unexpected situation that the vehicle or the occupant is likely to fall into when the vehicle departs, the plurality of levels being set by a combination of the progress of preparation by the passenger and the intention to cause the vehicle to depart by the driver; generate warning display information for causing a display device to perform a plurality of displays with different types corresponding to the plurality of levels for the driver; and cause the display device to display.

### CROSS-REFERENCE TO RELATED APPLICATION

The present application is a continuation of International Application No. PCT/JP2022/015242, filed on Mar. 29, 2022, which is incorporated herein by reference in its entirety.

### TECHNICAL FIELD

The present disclosure relates to a display control device and a display control method.

### BACKGROUND ART

When causing a vehicle to depart, a driver of the vehicle needs to cause the vehicle to depart after a state of the vehicle is a state in which there is no problem even if the vehicle departs, in other words, a state in which it is assumed that the vehicle or an occupant does not fall into an unexpected situation even if the vehicle departs.

In a case where the state of the vehicle is a state in which an unexpected situation may occur when the vehicle departs, the driver may need to take some measures such as stopping and waiting for an operation for departure of the vehicle or helping a passenger to prepare so that the vehicle can depart without falling into the unexpected situation.

By the way, as a technique for notifying a driver of a seat belt wearing state of a passenger, for example, Patent Literature 1 discloses a technique in which a seat belt state of an unseated seat, a seat belt state of a seated seat and an unworn seat belt, or a seat belt state of a seated seat and a worn seat belt are displayed in different colors, whereby the driver can visually recognize, from a driver's seat, whether or not the occupant is seated and whether or not the seat belt is worn at a glance.

### CITATION LIST

### Patent Literatures

Patent Literature 1: JP 2015-66983 A

### SUMMARY OF INVENTION

### Technical Problem

Severity of an unexpected situation that may occur when a vehicle departs varies stepwise depending on how far occupants including a driver and a passenger prepare for the departure of the vehicle. If the severity of the unexpected situation that may occur changes, some measures taken by the driver for the vehicle to depart without being fallen into the unexpected situation and necessity thereof also change. Therefore, when the vehicle is about to depart, it is desirable that the driver grasps a degree of severity of the unexpected situation that may occur when the driver causes the vehicle to depart.

Conventionally, there has been a problem that it is not possible to notify the driver of the degree of severity of the unexpected situation that may occur when the driver causes the vehicle to depart.

Note that the technique as disclosed in Patent Literature 1 merely notifies of the seat belt wearing state of the passenger by display of a certain expression, and it is not possible for the driver to grasp how serious an unexpected situation may occur when the driver causes the vehicle to depart by looking at the display. Therefore, the technique as disclosed in Patent Literature 1 still cannot solve the above problem.

The present disclosure has been made to solve the above problem, and an object of the present disclosure is to provide a display control device in which, in a case where there is a possibility that a vehicle or an occupant may fall into an unexpected situation when the driver causes the vehicle to depart, a driver can be warned of this in a display form in which a degree of severity of the unexpected situation can be recognized.

### Solution to Problem

A display control device according to the present disclosure includes: processing circuitry configured to acquire occupant information regarding an occupant; acquire operation information regarding an operation of a vehicle by a driver of the vehicle; determine progress of preparation by a passenger for departure of the vehicle on a basis of the acquired occupant information; determine intention to cause the vehicle to depart by the driver on a basis of the acquired operation information; determine a plurality of levels for warning the driver of severity of an unexpected situation that the vehicle or the occupant is likely to fall into when the vehicle departs, the plurality of levels being set by a combination of the progress of preparation by the passenger and the intention to cause the vehicle to depart by the driver, on a basis of the determined progress of preparation by the passenger and the determined intention to cause the vehicle to depart by the driver; generate warning display information for causing a display device to perform a plurality of displays with different types corresponding to the plurality of levels having been determined for the driver; and cause the display device to display based on the generated warning display information.

### Advantageous Effects of Invention

According to the present disclosure, in a case where there is a possibility that the vehicle or the occupant falls into an unexpected situation when the driver causes the vehicle to depart, the display control device can warn the driver of this in a display form in which a degree of severity of the unexpected situation can be known.

### BRIEF DESCRIPTION OF DRAWINGS

FIG. 1 is a diagram illustrating a configuration example of a display control device according to a first embodiment.

FIGS. 2A, 2B, 2C, and 2D are diagrams for explaining warning display information generated by a warning display information generating unit in the first embodiment.

FIGS. 3A, 3B, and 3C are diagrams for explaining progress display information generated by a progress display information generating unit in the first embodiment.

FIG. 4 is a diagram listing screen examples that a display control unit causes a display device to display in the first embodiment.

FIG. 5 is a diagram of the display device that displays a screen based on warning display information and progress display information in accordance with control of the display control unit as viewed from a vehicle interior in the first embodiment.

FIG. 6 is a flowchart for explaining an operation of the display control device according to the first embodiment.

FIG. 7 is a flowchart for explaining details of an example of processing in step ST2a in FIG. 6 by a departure preparation progress determining unit.

FIG. 8 is a flowchart for explaining details of processing in step ST2b in FIG. 6 by a departure intention determining unit.

FIG. 9 is a flowchart for explaining details of an example of processing in step ST3 in FIG. 6 by a warning level determining unit.

FIGS. 10A, 10B, and 10C are diagrams for explaining the progress display information generated by the progress display information generating unit in the first embodiment for displaying progress of preparation by a passenger in animation that changes with a lapse of time.

FIGS. 11A, 11B, 11C, and 11D are diagrams for explaining screen examples of the display device in a case where the display control unit causes the display device to display only a display based on the warning display information in the first embodiment.

FIGS. 12A and 12B are diagrams illustrating an example of a hardware configuration of the display control device according to the first embodiment.

### DESCRIPTION OF EMBODIMENTS

Hereinafter, embodiments of the present disclosure will be described in detail with reference to the drawings.

### First Embodiment

A display control device according to a first embodiment is mounted on a vehicle, for example. The display control device performs display control of a display device mounted on the vehicle. The display device is assumed to be, for example, a meter panel disposed in front of a steering wheel in the vehicle.

For example, when occupants including a driver and a passenger get into the vehicle and the driver operates the vehicle to cause the vehicle to depart, the display control device causes the display device to display a display for warning the driver that an unexpected situation may occur when the vehicle departs. Specifically, the display control device causes the display device to display a display for warning the driver that an unexpected situation may occur when the vehicle departs, in a form in which severity of the unexpected situation that may occur is known.

Note that, in the first embodiment, the display device is assumed to be the meter panel as described above, but this is merely an example, and the display device may be, for example, a display device disposed in a center console provided in a front portion of a vehicle interior, or may be a display device disposed in a rearview mirror. The display device to be displayed by the display control device may be any display device provided at a position visually recognizable by the driver gazing ahead of the vehicle without largely moving a line of sight.

In the following first embodiment, as an example, it is assumed that a total of two persons including a driver and one passenger get on the vehicle and depart by the vehicle. For example, the passenger is assumed to be seated on a rear seat.

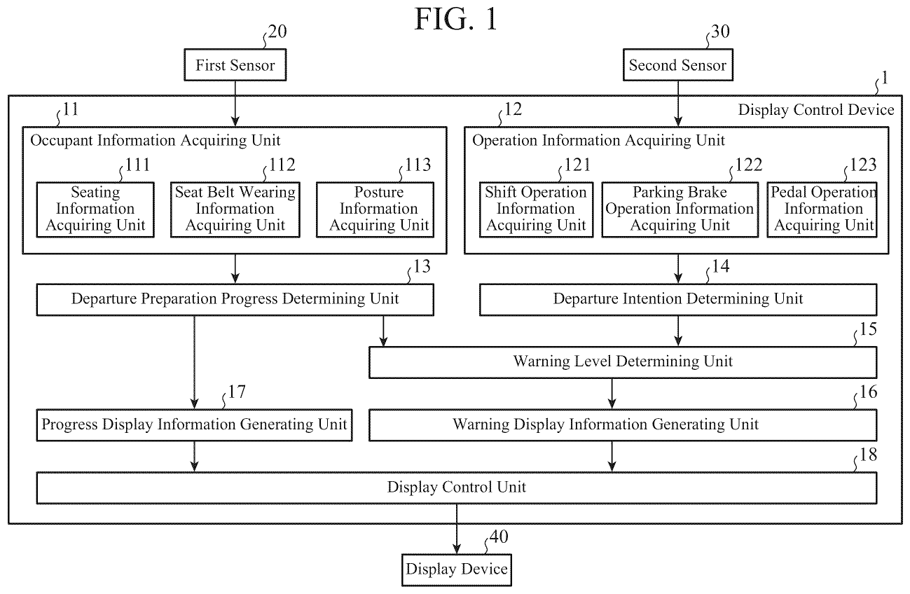

FIG. 1 is a diagram illustrating a configuration example of a display control device 1 according to the first embodiment. Note that illustration of the vehicle is omitted in FIG. 1.

The display control device 1 is connected to a first sensor 20, a second sensor 30, and a display device 40.

The first sensor 20 is mounted on the vehicle and detects a state of the vehicle interior. The first sensor 20 outputs information regarding the detected state of the vehicle interior (hereinafter referred to as “first sensor information”) to the display control device 1. Details of the first sensor information will be described later.

In the first embodiment, the first sensor 20 is assumed to be various sensors mounted on the vehicle, such as a camera sensor disposed in a place where the vehicle interior can be imaged, a load sensor or a contact sensor disposed in a seat, and a seat belt sensor provided in a winding portion or a fastening portion of a seat belt. The load sensor or the contact sensor may be provided, for example, on a floor portion in the vehicle interior.

Note that, although only one first sensor 20 is illustrated in FIG. 1, this is merely an example. The display control device 1 can be connected to a plurality of first sensors 20 of different types.

The second sensor 30 is mounted on the vehicle and detects various operations performed on the vehicle. The second sensor 30 outputs information regarding the detected various operations (hereinafter referred to as “second sensor information”) to the display control device 1. Details of the second sensor information will be described later.

In the first embodiment, the second sensor 30 is assumed to be various sensors such as a shift position sensor, a brake sensor that detects an operation state of a parking brake, a pedal sensor that detects a pedal operation, and a grip sensor disposed on a steering wheel.

Note that, although only one second sensor 30 is illustrated in FIG. 1, this is merely an example. The display control device 1 can be connected to a plurality of second sensors 30 of different types.

Further, the first sensor 20 and the second sensor 30 may be a common sensor. For example, the first sensor 20 and the second sensor 30 may be a common camera sensor.

The display device 40 is a meter panel, and performs a display based on control of the display control device 1. Details of a screen displayed by the display device 40 will be described later.

The display control device 1 includes an occupant information acquiring unit 11, an operation information acquiring unit 12, a departure preparation progress determining unit 13, a departure intention determining unit 14, a warning level determining unit 15, a warning display information generating unit 16, a progress display information generating unit 17, and a display control unit 18.

The occupant information acquiring unit 11 includes a seating information acquiring unit 111, a seat belt wearing information acquiring unit 112, and a posture information acquiring unit 113.

The operation information acquiring unit 12 includes a shift operation information acquiring unit 121, a parking brake operation information acquiring unit 122, and a pedal operation information acquiring unit 123.

The occupant information acquiring unit 11 acquires information regarding a state of an occupant (hereinafter referred to as “occupant information”) on the basis of the first sensor information output from the first sensor 20. The occupant information includes, for example, seating information regarding seating of an occupant, seat belt wearing information regarding wearing of a seat belt by the occupant, and posture information regarding posture of the occupant. Note that, in the occupant information, the seating information, the seat belt wearing information, and the posture information are associated with information that can specify a position of the occupant. In the first embodiment, the position of the occupant is represented by, for example, a position of a seat on which the occupant is about to be seated or is seated.

The seating information includes, for example, information regarding presence or absence of the occupant and information regarding whether or not the occupant is seated on the seat.

The seat belt wearing information includes, for example, information regarding whether or not the occupant has operated the seat belt and information regarding whether or not the occupant has completed wearing of the seat belt.

The posture information includes, for example, information regarding presence or absence of unsafe posture of the occupant.

The seating information acquiring unit 111 acquires seating information.

For example, the seating information acquiring unit 111 acquires a captured image obtained by imaging the vehicle interior as the first sensor information from the camera sensor which is the first sensor 20. Then, the seating information acquiring unit 111 performs image recognition processing using a known image recognition technique on the captured image to detect presence or absence of an occupant and whether the occupant is seated on the seat. Note that the seating information acquiring unit 111 can specify the position of the occupant and the seat on which the occupant is seated on the basis of the captured image.

Furthermore, for example, the seating information acquiring unit 111 may acquire information indicating a load (hereinafter referred to as “load information”) or information indicating presence or absence of contact (hereinafter referred to as “contact information”) as the first sensor information from the load sensor or the contact sensor which is the first sensor 20, and detect presence or absence of an occupant and whether the occupant is seated on the seat on the basis of the load information or the contact information. Note that the seating information acquiring unit 111 can specify the position of the occupant and the seat on which the occupant is seated on the basis of the load information or the contact information.

The seating information acquiring unit 111 acquires information regarding the presence or absence of the occupant and information regarding whether or not the occupant is seated on the seat, which have been detected, as the seating information.

Note that, here, it is assumed that the seating information acquiring unit 111 detects the presence or absence of the occupant and whether the occupant is seated on the seat on the basis of the captured image, the load information, or the contact information, but this is merely an example. For example, the camera sensor may detect the presence or absence of the occupant and whether the occupant is seated on the seat, and output information regarding the presence or absence of the occupant and information regarding whether or not the occupant is seated on the seat to the seating information acquiring unit 111 as the seating information. Furthermore, for example, the load sensor or the contact sensor may detect the presence or absence of the occupant and whether the occupant is seated on the seat, and output information regarding the presence or absence of the occupant and information regarding whether or not the occupant is seated on the seat to the seating information acquiring unit 111 as the seating information.

Furthermore, for example, the seating information acquiring unit 111 may output the first sensor information as the seating information to the departure preparation progress determining unit 13, and the departure preparation progress determining unit 13 may detect the presence or absence of the occupant and whether the occupant is seated on the seat. Details of the departure preparation progress determining unit 13 will be described later.

The seat belt wearing information acquiring unit 112 acquires seat belt wearing information.

For example, the seat belt wearing information acquiring unit 112 acquires, as the first sensor information, the captured image obtained by imaging the vehicle interior from the camera sensor that is the first sensor 20. Then, the seat belt wearing information acquiring unit 112 performs image recognition processing using a known image recognition technique on the captured image to detect whether or not the occupant has operated the seat belt and whether or not the occupant has completed wearing of the seat belt.

In addition, for example, the seat belt wearing information acquiring unit 112 may acquire, as the first sensor information, information regarding whether a buckle switch of the seat belt is turned on or off, information regarding an amount of withdrawal or information regarding an amount of winding of the seat belt (hereinafter referred to as “seatbelt sensor information”) from the seat belt sensor which is the first sensor 20, and detect whether or not the occupant has operated the seat belt and whether or not the occupant has completed wearing of the seat belt on the basis of the seat belt sensor information. Note that, the seat belt wearing information acquiring unit 112 can specify the position of the occupant and the seat on which the occupant is seated on the basis of the seat belt sensor information.

The seat belt wearing information acquiring unit 112 acquires, as the seat belt wearing information, the detected information regarding whether or not the occupant has operated the seat belt and whether or not the occupant has completed wearing of the seat belt.

Note that, here, it is assumed that the seat belt wearing information acquiring unit 112 detects whether or not the occupant has operated the seat belt and whether or not the occupant has completed wearing of the seat belt on the basis of the captured image or the seat belt sensor information, but this is merely an example. For example, the camera sensor may detect whether or not the occupant has operated the seat belt and whether the occupant has completed wearing of the seat belt, and output information regarding whether or not the occupant has operated the seat belt and whether or not the occupant has completed wearing of the seat belt to the seat belt wearing information acquiring unit 112 as the seat belt wearing information. Furthermore, for example, the seat belt sensor may detect whether or not the occupant has operated the seat belt and whether the occupant has completed wearing of the seat belt, and output information regarding whether or not the occupant has operated the seat belt and whether or not the occupant has completed wearing of the seat belt to the seat belt wearing information acquiring unit 112 as the seat belt wearing information.

In addition, for example, the seat belt wearing information acquiring unit 112 may output the first sensor information to the departure preparation progress determining unit 13, and the departure preparation progress determining unit 13 may detect whether or not the occupant has operated the seat belt and whether or not the occupant has completed wearing of the seat belt.

The posture information acquiring unit 113 acquires posture information.

For example, the posture information acquiring unit 113 acquires, as the first sensor information, a captured image obtained by imaging the vehicle interior from the camera sensor which is the first sensor 20. Then, the posture information acquiring unit 113 performs image recognition processing using a known image recognition technique on the captured image to detect presence or absence of unsafe posture of the occupant. Since the technique of detecting unsafe posture of the occupant on the basis of the captured image is a known technique, detailed description thereof will be omitted.

Further, for example, the posture information acquiring unit 113 may acquire load information or contact information as the first sensor information from the load sensor or the contact sensor which is the first sensor 20, and detect the presence or absence of unsafe posture of the occupant on the basis of the load information or the contact information. Since the technique of detecting unsafe posture of the occupant on the basis of the load information or the contact information is a known technique, detailed description thereof will be omitted.

The posture information acquiring unit 113 acquires the detected information regarding the presence or absence of unsafe posture of the occupant as the posture information.

Note that, here, it is assumed that the posture information acquiring unit 113 detects the presence or absence of unsafe posture of the occupant on the basis of the captured image, the load information, or the contact information, but this is merely an example. For example, the camera sensor may detect the presence or absence of unsafe posture of the occupant, and output information regarding the presence or absence of unsafe posture of the occupant to the posture information acquiring unit 113 as the posture information. Furthermore, for example, the load sensor or the contact sensor may detect the presence or absence of unsafe posture of the occupant, and output information regarding the presence or absence of unsafe posture of the occupant to the posture information acquiring unit 113 as the posture information.

Further, for example, the posture information acquiring unit 113 may output the first sensor information as the posture information to the departure preparation progress determining unit 13, and the departure preparation progress determining unit 13 may detect the presence or absence of unsafe posture of the occupant.

The occupant information acquiring unit 11 outputs the occupant information including the seating information acquired by the seating information acquiring unit 111, the seat belt wearing information acquired by the seat belt wearing information acquiring unit 112, and the posture information acquired by the posture information acquiring unit 113 to the departure preparation progress determining unit 13.

The operation information acquiring unit 12 acquires operation information on the basis of the second sensor information output from the second sensor 30. The operation information includes, for example, shift operation information regarding a shift position, parking brake operation information regarding an operation of a parking brake, and pedal operation information regarding a pedal operation.

The shift operation information includes, for example, shift position information.

The parking brake operation information includes, for example, information indicating that the parking brake has been released.

The pedal operation information includes information regarding whether a driver has performed an accelerator operation. The pedal operation information may include information regarding a depression amount of a brake pedal, a release amount of the brake pedal, a depression amount of an accelerator pedal, and a release amount of the accelerator pedal.

The shift operation information acquiring unit 121 acquires shift operation information.

For example, the shift operation information acquiring unit 121 acquires information indicating a current shift position (hereinafter referred to as “shift position information”) as the second sensor information from the shift position sensor which is the second sensor 30. Then, on the basis of the shift position information, the shift operation information acquiring unit 121 detects whether the driver has set the shift position to a shift P, a shift D, or a shift R.

The shift operation information acquiring unit 121 acquires, as the shift operation information, the detected information regarding whether the driver has set the shift position to the shift P, the shift D, or the shift R.

Note that, here, it is assumed that the shift operation information acquiring unit 121 detects whether the driver has set the shift position to the shift P, the shift D, or the shift R on the basis of shift operation information, but this is merely an example. For example, the shift position sensor may detect whether the driver has set the shift position to the shift P, the shift D, or the shift R, and output information indicating whether the driver has set the shift position to the shift P, the shift D, or the shift R to the shift operation information acquiring unit 121 as the shift operation information.

Further, for example, the shift operation information acquiring unit 121 may output the second sensor information as the shift operation information to the departure intention determining unit 14, and the departure intention determining unit 14 may detect whether the driver has set the shift position to the shift P, the shift D, or the shift R. Details of the departure intention determining unit 14 will be described later.

The parking brake operation information acquiring unit 122 acquires parking brake operation information.

For example, the parking brake operation information acquiring unit 122 acquires information regarding the parking brake (hereinafter referred to as “parking brake information”) as the second sensor information from the brake sensor which is the second sensor 30. Then, the parking brake operation information acquiring unit 122 detects that the driver has released the parking brake on the basis of the parking brake information.

The parking brake operation information acquiring unit 122 acquires, as the parking brake operation information, the detected information regarding whether the driver has released the parking brake.

Note that, here, it is assumed that the parking brake operation information acquiring unit 122 detects that the driver has released the parking brake on the basis of the parking brake information, but this is merely an example. For example, the brake sensor may detect that the driver has released the parking brake, and output information indicating that the driver has released the parking brake to the parking brake operation information acquiring unit 122 as the parking brake operation information.

Further, for example, the parking brake operation information acquiring unit 122 may output the second sensor information as the parking brake operation information to the departure intention determining unit 14, and the departure intention determining unit 14 may detect that the driver has released the parking brake.

The pedal operation information acquiring unit 123 acquires pedal operation information.

For example, the pedal operation information acquiring unit 123 acquires, as the second sensor information, information regarding an operation of the brake pedal (hereinafter referred to as “pedal information”) from the pedal sensor which is the second sensor 30. Then, the pedal operation information acquiring unit 123 detects whether the driver has performed an accelerator operation on the basis of the pedal information. The pedal operation information acquiring unit 123 may detect the depression amount of the brake pedal, the release amount of the brake pedal, the depression amount of the accelerator pedal, and the release amount of the accelerator pedal.

The pedal operation information acquiring unit 123 acquires, as the pedal operation information, the detected information regarding whether the driver has performed the accelerator operation. The pedal operation information acquiring unit 123 may acquire, as the pedal operation information, information regarding the depression amount of the brake pedal, the release amount of the brake pedal, the depression amount of the accelerator pedal, or the release amount of the accelerator pedal.

Note that, here, it is assumed that the pedal operation information acquiring unit 123 detects whether the driver has performed the accelerator operation on the basis of the pedal information, but this is merely an example. For example, the pedal sensor may detect whether the driver has performed the accelerator operation, and output information regarding whether or not the driver has performed the accelerator operation to the pedal operation information acquiring unit 123 as the pedal operation information.

In addition, for example, the pedal operation information acquiring unit 123 may output the second sensor information as the pedal operation information to the departure intention determining unit 14, and the departure intention determining unit 14 may detect whether the driver has performed the accelerator operation.

The operation information acquiring unit 12 outputs the operation information including the shift operation information acquired by the shift operation information acquiring unit 121, the parking brake operation information acquired by the parking brake operation information acquiring unit 122, and the pedal operation information acquired by the pedal operation information acquiring unit 123 to the departure intention determining unit 14.

On the basis of the occupant information acquired by the occupant information acquiring unit 11, the departure preparation progress determining unit 13 determines progress of preparation for departure of the vehicle by a passenger. In the following description, “preparation for departure of the vehicle” by the passenger is also simply referred to as “preparation”.

When the passenger goes out in the vehicle, it is assumed that the passenger prepares for departure in the order of, for example, getting in the vehicle, seating, wearing a seat belt, and correcting posture in such a manner as not to stagger even if the vehicle starts to move. In the first embodiment, the departure preparation progress determining unit 13 assumes that the passenger prepares in the order as described above, and determines progress of preparation performed in the order as described above in four stages of “none”, “early stage”, “middle stage”, and “completed”. In the first embodiment, a state in which the progress by the passenger is “none” indicates a state in which there is no passenger in the first place. If there is no passenger, there is no progress of preparation by the passenger. A state in which the progress by the passenger is “early stage” indicates a state in which the passenger gets in the vehicle and is ready to be seated. A state in which the progress by the passenger is “middle stage” indicates a state in which the passenger is ready to wear the seat belt after being seated. A state in which the progress by the passenger is “completed” indicates a state in which the passenger completes wearing of the seat belt and is ready to correct the posture in such a manner as not to stagger even if the vehicle starts to move.

In the first embodiment, for example, the preparation by the passenger in the four stages is expressed numerically as “0: none”, “1: early stage”, “2: middle stage”, and “3: completed”. That is, the larger the numerical value indicating the preparation by the passenger is, the more the preparation by the passenger is progressed.

An example of a method of determining the progress of preparation by the passenger by the departure preparation progress determining unit 13 will be described.

First, the departure preparation progress determining unit 13 determines presence or absence of the passenger on the basis of the occupant information. Specifically, the departure preparation progress determining unit 13 determines the presence or absence of the passenger on the basis of the seating information included in the occupant information.

When determining that there is no passenger, the departure preparation progress determining unit 13 determines that the progress of preparation by the passenger is “0: none”.

When determining that there is a passenger, the departure preparation progress determining unit 13 determines whether or not the passenger has completed seating. Specifically, the departure preparation progress determining unit 13 determines whether or not the passenger has completed seating on the basis of the seating information included in the occupant information.

When determining that the passenger has not completed seating, the departure preparation progress determining unit 13 determines that the progress of preparation by the passenger is “1: early stage”. The “1: early stage” indicates a state in which the passenger is present but the passenger has not completed seating.

When determining that the passenger has completed seating, the departure preparation progress determining unit 13 determines whether or not the passenger has operated the seat belt. Specifically, the departure preparation progress determining unit 13 determines whether or not the passenger has operated the seat belt on the basis of the seat belt wearing information included in the occupant information.

When determining that the passenger has not operated the seat belt, the departure preparation progress determining unit 13 determines that the progress of preparation by the passenger is “1: early stage”. The “1: early stage” indicates a state in which the passenger has completed seating but the passenger has not yet started a seat belt wearing operation.

When determining that the passenger has operated the seat belt, the departure preparation progress determining unit 13 determines whether or not the passenger has completed wearing of the seat belt. Specifically, the departure preparation progress determining unit 13 determines whether or not the passenger has completed wearing of the seat belt on the basis of the seat belt wearing information included in the occupant information.

When determining that the passenger has not completed wearing of the seat belt, the departure preparation progress determining unit 13 determines that the progress of preparation by the passenger is “2: middle stage”. The “2: middle stage” indicates a state in which the passenger has completed seating and started operating the seat belt, but has not yet completed wearing of the seat belt.

When determining that the passenger has completed wearing of the seat belt, the departure preparation progress determining unit 13 determines presence or absence of unsafe posture of the passenger. Specifically, the departure preparation progress determining unit 13 determines the presence or absence of unsafe posture of the passenger on the basis of the posture information included in the occupant information.

When determining that the posture of the passenger is unsafe, the departure preparation progress determining unit 13 determines that the progress of preparation by the passenger is “2: middle stage”. The “2: middle stage” indicates a state in which the passenger has completed wearing of the seat belt but has not yet corrected his or her posture in such a manner as not to stagger.

When determining that there is no unsafe posture of the passenger, the departure preparation progress determining unit 13 determines that the progress of preparation by the passenger is “3: completed”. The “3: completed” indicates a state in which the passenger has completed the preparation for the departure of the vehicle.

The departure preparation progress determining unit 13 outputs the determined information regarding the progress of preparation by the passenger (hereinafter referred to as “departure preparation progress information”) to the warning level determining unit 15 and the progress display information generating unit 17. The departure preparation progress information includes information indicating the progress of preparation by the passenger, here, the numerical values of “0” to “3”. In the departure preparation progress information, the information indicating the progress of preparation by the passenger and a position of the passenger may be associated with each other.

The departure intention determining unit 14 determines intention to cause the vehicle to depart by the driver on the basis of the operation information acquired by the operation information acquiring unit 12. In the following description, the “intention to cause the vehicle to depart” by the driver is also simply referred to as “intention to depart”.

When the driver drives the vehicle and leaves, the driver is assumed to operate the vehicle in the order of, for example, shifting from “P” to “D” or “R”, releasing the parking brake, and stepping on the accelerator pedal as the operation for causing the vehicle to depart. In the first embodiment, it is assumed that the driver operates the vehicle in the order as described above in order to cause the vehicle to depart. As the vehicle is operated in the order as described above, it can be said that the driver is ready to cause the vehicle to depart, in other words, the intention to cause the vehicle depart by the driver is increasing.

In the first embodiment, the departure intention determining unit 14 regards progress of the operation of the vehicle performed in the order as described above as an increase in the intention to depart by the driver, and determines the intention to depart in three stages of “low”, “medium”, and “high”. Note that the intention to depart may also be indicated by a numerical value similarly to the progress of preparation by the passenger described above.

An example of a method of determining the intention to depart by the driver by the departure intention determining unit 14 will be described.

First, the departure intention determining unit 14 determines a shift position and a parking brake releasing operation on the basis of the operation information. Specifically, the departure intention determining unit 14 determines the shift position and the parking brake releasing operation on the basis of the shift operation information and the parking brake operation information included in the operation information.

When the shift operation to set the shift D or the shift R is not performed, that is, the shift position remains at the shift P, and the operation to release the parking brake is not performed, the departure intention determining unit 14 determines that the intention to depart by the driver is “low”.

When the shift operation to set the shift D or the shift R is not performed, that is, the shift position remains at the shift P, and the operation to release the parking brake is performed, the departure intention determining unit 14 determines that the intention to depart by the driver is “medium”.

Further, when the shift operation to set the shift D or the shift R is performed and the operation to release the parking brake is not performed, the departure intention determining unit 14 also determines that the intention to depart by the driver is “medium”.

When the shift operation to set the shift D or the shift R is performed and the operation to release the parking brake is performed, the departure intention determining unit 14 next determines presence or absence of the accelerator operation on the basis of the operation information. Specifically, the departure intention determining unit 14 determines the presence or absence of the accelerator operation on the basis of accelerator operation information of the operation information.

Even when the shift operation to set the shift D or the shift R is performed and the operation to release the parking brake is performed, the departure intention determining unit 14 determines that the intention to depart by the driver is “medium” if the accelerator operation is not performed.

When the shift operation to set the shift D or the shift R is performed and the operation to release the parking brake is performed, and further when the accelerator operation is performed, the departure intention determining unit 14 determines that the intention to depart by the driver is “high”.

The departure intention determining unit 14 outputs information regarding the intention to depart by the driver (hereinafter referred to as “departure intention information”) to the warning level determining unit 15. The departure intention information includes information indicating the intention to depart by the driver (“low”, “medium”, or “high”).

On the basis of the progress of preparation by the passenger determined by the departure preparation progress determining unit 13 and the intention to cause the vehicle to depart by the driver determined by the departure intention determining unit 14, the warning level determining unit 15 determines a level for warning the driver about severity of an unexpected situation that the vehicle or the occupant may fall into when the vehicle departs (hereinafter referred to as a “warning level”).

In the first embodiment, as an example, the warning level determining unit 15 sets the warning level for the driver to five levels of “level 0” to “level 4”. The warning level indicates that as a value of the warning level is larger, the state of the vehicle is a state in which an unexpected situation that the vehicle or the occupant may fall into when the vehicle departs is more serious. In other words, the larger the value of the warning level is, the higher the importance of the warning to the driver is. As the state of the vehicle is a state in which an unexpected situation that the vehicle or the occupant may fall into when the vehicle departs is more serious, the driver needs to pay more attention so that the vehicle can depart without the vehicle or the occupant falling into the unexpected situation.

An example of a method for determining a warning level by the warning level determining unit 15 according to the first embodiment based on the progress of preparation by the passenger and the intention to depart by the driver will be described.

For example, the warning level determining unit 15 determines the warning level in accordance with a preset condition (hereinafter referred to as “warning level determination condition”).

The warning level determination condition is set in advance by an administrator or the like, and is stored in a place that can be referred to by the warning level determining unit 15.

As the warning level determination condition, for example, the following (Condition A) to (Condition F) are set.

### (Condition A)

When the intention to depart by the driver is “low”, the warning level is “level 0” regardless of the progress of preparation by the passenger.

### (Condition B)

Even when the intention to depart by the driver is “medium” or “high”, if the progress of preparation by the passenger is “0: none” or “3: completed”, the warning level is “level 0”.

### (Condition C)

When the intention to depart by the driver is “medium” and the progress of preparation by the passenger is “2: middle stage”, the warning level is “level 1”.

### (Condition D)

When the intention to depart by the driver is “medium” and the progress of preparation by the passenger is “1: early stage”, the warning level is “level 2”.

### (Condition E)

When the intention to depart by the driver is “high” and the progress of preparation by the passenger is “2: middle stage”, the warning level is “level 3”.

### (Condition F)

When the intention to depart by the driver is “high” and the progress of preparation by the passenger is “1: early stage”, the warning level is “level 4”.

Note that a content of the warning level determination condition is merely an example, and the administrator or the like can set the warning level determination condition according to the needs. The administrator or the like sets the warning level determination condition in such a manner that the warning level is set by a combination of the intention to depart by the driver and the progress of preparation by the passenger.

The warning level determining unit 15 outputs a determination result of the warning level (hereinafter referred to as a “level determination result”) to the warning display information generating unit 16.

In the level determination result, the warning level, the information indicating the intention to depart by the driver, and the information indicating the progress of preparation by the passenger are associated with each other.

On the basis of the level determination result output from the warning level determining unit 15, the warning display information generating unit 16 generates information for causing a display corresponding to the warning level (hereinafter referred to as “warning display information”) determined by the warning level determining unit 15 to be performed for the driver.

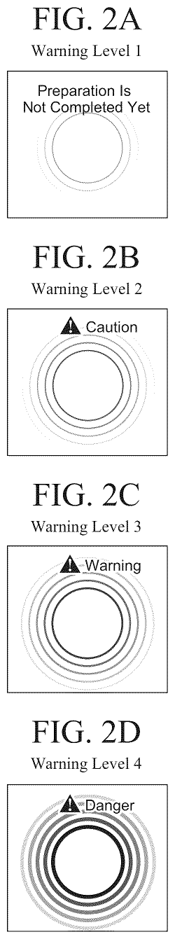

Here, FIGS. 2A, 2B, 2C, and 2D are diagrams for explaining warning display information generated by the warning display information generating unit 16 in the first embodiment.

The warning display information generating unit 16 generates warning display information for displaying a screen as illustrated in FIG. 2A, 2B, 2C, or 2D on the display device 40. Display control on the display device 40 is performed by the display control unit 18 to be described later. Note that a region in the display device 40 where the screen as illustrated in FIG. 2A, 2B, 2C, or 2D is displayed is predetermined.

For example, when the warning level is “level 1”, the warning display information generating unit 16 generates warning display information for displaying a screen on which display elements as illustrated in FIG. 2A, specifically, a message “preparation is not completed yet” and an icon including a plurality of circles are displayed.

For example, when the warning level is “level 2”, the warning display information generating unit 16 generates warning display information for displaying a screen on which display elements as illustrated in FIG. 2B, specifically, a message “caution” and an icon including a plurality of circles are displayed.

For example, when the warning level is “level 3”, the warning display information generating unit 16 generates warning display information for displaying a screen on which display elements as illustrated in FIG. 2C, specifically, a message “warning” and an icon including a plurality of circles are displayed.

For example, when the warning level is “level 4”, the warning display information generating unit 16 generates warning display information for displaying a screen on which display elements as illustrated in FIG. 2D, specifically, a message of “danger” and an icon including a plurality of circles are displayed.

When the warning level is “level 0”, the warning display information generating unit 16 does not generate warning display information.

The warning display information generating unit 16 generates warning display information in such a manner that the display is emphasized as the warning level is higher. For example, the warning display information generating unit 16 generates the warning display information in such a manner that the circle icon illustrated in FIG. 2B is emphasized darker than the circle icon illustrated in FIG. 2A, the circle icon illustrated in FIG. 2C is emphasized darker than the circle icon illustrated in FIG. 2B, and the circle icon illustrated in FIG. 2D is emphasized darker than the circle icon illustrated in FIG. 2C. The warning display information generating unit 16 may generate the warning display information in such a manner as to blink the circle icon.

Note that, in FIGS. 2A, 2B, 2C, and 2D, a square surrounding the message and the circle icon is illustrated for convenience, but the square is not displayed on the display device 40.

As described above, the warning display information generating unit 16 generates warning display information for causing to perform display for warning severity of an unexpected situation that may occur when the vehicle departs in such a manner that the display is performed in a form in which the driver pays more attention as the warning level is higher.

The warning display information generating unit 16 outputs the generated warning display information to the display control unit 18 in association with the information indicating the intention to depart by the driver and the information indicating the progress of preparation by the passenger.

The progress display information generating unit 17 generates information for causing to perform display corresponding to the progress of preparation by the passenger (hereinafter referred to as “progress display information”) on the basis of the progress of preparation by the passenger determined by the departure preparation progress determining unit 13. Specifically, on the basis of the progress of preparation by the passenger determined by the departure preparation progress determining unit 13, the progress display information generating unit 17 generates progress display information for causing to perform display for notifying the driver of a progress state of preparation by the passenger in a form corresponding to the progress of preparation by the passenger.

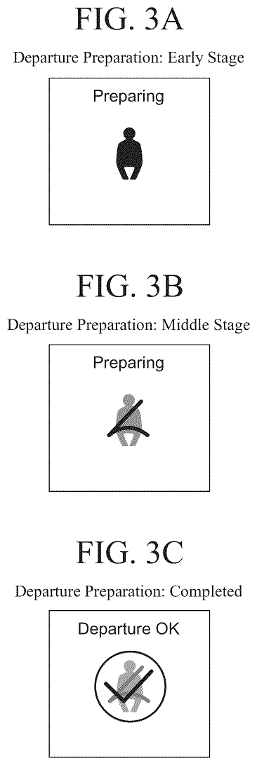

Here, FIGS. 3A, 3B, and 3C are diagrams for explaining progress display information generated by the progress display information generating unit 17 in the first embodiment.

The progress display information generating unit 17 generates progress display information for displaying a screen as illustrated in FIG. 3A, 3B, or 3C on the display device 40. Display control on the display device 40 is performed by the display control unit 18 to be described later. Note that a region in the display device 40 where the screen as illustrated in FIG. 3A, 3B, 3C, or 3D is displayed is predetermined.

For example, when the progress of preparation by the passenger is “1: early stage”, the progress display information generating unit 17 generates progress display information for displaying a screen on which a message “preparing” and an icon indicating a person are displayed as illustrated in FIG. 3A.

For example, when the progress of preparation by the passenger is “2: middle stage”, the progress display information generating unit 17 generates progress display information for displaying a screen on which a message “preparing” and an icon indicating the person wearing the seat belt are displayed as illustrated in FIG. 3B.

For example, when the progress of preparation by the passenger is “3: completed”, the progress display information generating unit 17 generates progress display information for displaying a screen on which a message “departure OK” and an icon on which a check mark indicating completion of wearing of the seat belt is superimposed on the person wearing the seat belt are displayed as illustrated in FIG. 3C.

When the progress of preparation by the passenger is “0: none”, the progress display information generating unit 17 does not generate progress display information.

The progress display information generating unit 17 generates the progress display information in such a manner that the icon illustrated in FIG. 3B is more prepared for the departure of the vehicle by the passenger than the icon illustrated in FIG. 3A, and the icon illustrated in FIG. 3C is more prepared for the departure of the vehicle by the passenger than the icon illustrated in FIG. 3B.

Note that, in FIGS. 3A, 3B, and 3C, a square surrounding the message and the icon is illustrated for convenience, but the square is not displayed on the display device 40.

As described above, the progress display information generating unit 17 generates the progress display information for notifying the driver of the progress state of preparation by the passenger in such a manner that the display is performed in a form indicating that the preparation is in progress as the preparation for departure by the passenger is in progress, in other words, as the numerical value indicating the preparation for departure by the passenger is larger.

The progress display information generating unit 17 outputs the generated progress display information to the display control unit 18 in association with the information indicating the progress of preparation by the passenger.

The display control unit 18 causes the display device 40 to perform display based on the warning display information generated by the warning display information generating unit 16 and to perform display based on the progress display information generated by the progress display information generating unit 17.

For example, the display control unit 18 causes the display device 40 to display a message and an icon based on the warning display information generated by the warning display information generating unit 16 and a message and an icon based on the progress display information generated by the progress display information generating unit 17 in a superimposed manner. The display control unit 18 can associate the warning display information and the progress display information with each other by the information indicating the progress of preparation by the passenger associated with each of the warning display information and the progress display information.

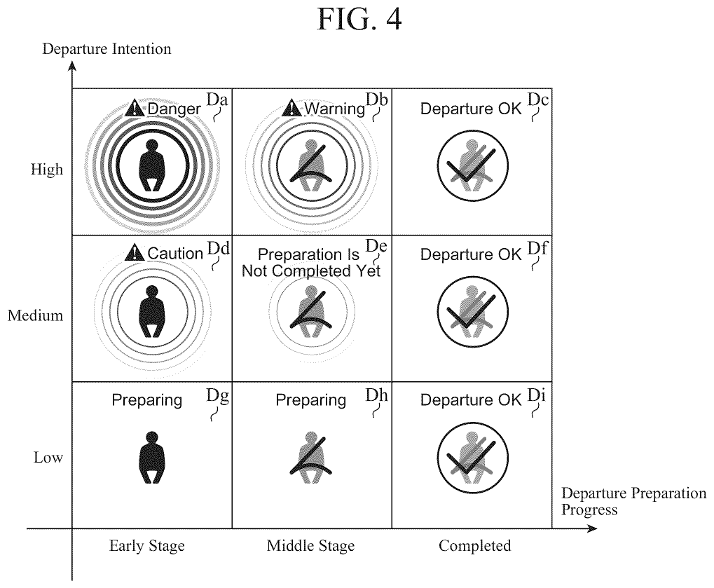

FIG. 4 is a diagram listing screen examples that the display control unit 18 causes the display device 40 to display in the first embodiment.

For example, the warning display information for displaying the screen of the warning level 4 as illustrated in FIG. 2D is associated with the progress display information for displaying the screen of the progress of preparation by the passenger of “1: early stage” as illustrated in FIG. 3A. Therefore, the display control unit 18 causes the display device 40 to display a screen as indicated by Da in FIG. 4. For example, in a case where the messages overlap as a result of superimposing the display based on the warning display information and the display based on the progress display information, the display control unit 18 causes the message based on the warning display information to be preferentially displayed. In the screen indicated by Da in FIG. 4, the display control unit 18 gives priority to the message “danger” over the message “preparing”. As a result, the message “preparing” is not displayed.

In addition, for example, the warning display information for displaying the screen of the warning level 3 as illustrated in FIG. 2C is associated with the progress display information for displaying the screen of the progress of preparation by the passenger “2: middle stage” as illustrated in FIG. 3B. Therefore, the display control unit 18 causes the display device 40 to display a screen as indicated by Db in FIG. 4.

In addition, for example, the warning display information for displaying the screen of the warning level 2 as illustrated in FIG. 2B is associated with the progress display information for displaying the screen of the progress of preparation by the passenger “1: early stage” as illustrated in FIG. 3A. Therefore, the display control unit 18 causes the display device 40 to display a screen as indicated by Dd in FIG. 4.

In addition, for example, the warning display information for displaying the screen of the warning level 1 as illustrated in FIG. 2A is associated with the progress display information for displaying the screen of the progress of preparation by the passenger “2: middle stage” as illustrated in FIG. 3B. Therefore, the display control unit 18 causes the display device 40 to display a screen as indicated by De in FIG. 4.

Furthermore, for example, in a case where the warning display information generating unit 16 does not generate the warning display information and the progress display information generating unit 17 generates the progress display information, the display control unit 18 causes the display device 40 to display only a screen based on the progress display information. For example, when the progress of preparation by the passenger is “3: completed”, the warning level is “level 0”, and thus the warning display information is not generated, but the progress display information is generated. That is, only the progress display information generated by the progress display information generating unit 17 is output to the display control unit 18.

In this case, the display control unit 18 causes the display device 40 to display a screen based on the progress display information (see Dc, Df, Dg, Dh, and Di in FIG. 4).

Note that, when the warning display information generating unit 16 does not generate the warning display information and the progress display information generating unit 17 does not generate the progress display information, the display control unit 18 displays neither the screen based on the warning display information nor the screen based on the progress display information on the display device 40. For example, when the progress of preparation by the passenger is “0: none”, the progress display information is not generated, and the warning level is set to “level 0”, so that the warning display information is not generated either. That is, neither the warning display information generated by the warning display information generating unit 16 nor the progress display information generated by the progress display information generating unit 17 is output to the display control unit 18.

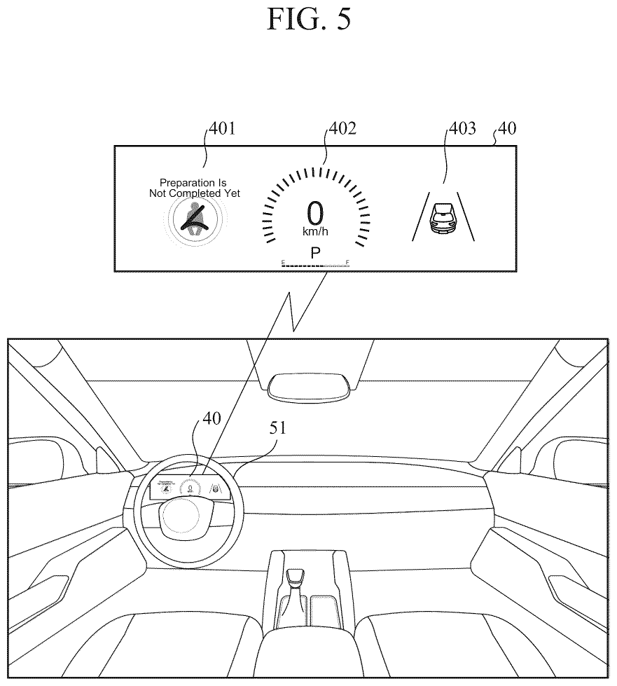

FIG. 5 is a diagram of the display device 40 that displays a screen based on the warning display information and the progress display information in accordance with control of the display control unit 18 as viewed from the vehicle interior in the first embodiment.

In the first embodiment, as described above, the display device 40 is assumed to be a meter panel disposed in front of a steering wheel (indicated by 51 in FIG. 5) in the vehicle. Note that, in FIG. 5, the vehicle is a left-hand drive vehicle, but this is merely an example. The vehicle may be a right-hand drive vehicle.

In FIG. 5, as an example, the display device 40 has a display area on a left side as viewed from the vehicle interior (indicated by 401 in FIG. 5), a display area at the center as viewed from the vehicle interior (indicated by 402 in FIG. 5), and a display area on a right side as viewed from the vehicle interior (indicated by 403 in FIG. 5).

The screen based on the warning display information and the progress display information is displayed in the display area on the left side as viewed from the vehicle interior.

In FIG. 5, the display control unit 18 causes the display device 40 to display a screen on which the message and the icon based on the warning display information corresponding to the warning level 1 and the message and the icon based on the progress display information corresponding to the progress of preparation by the passenger “2: middle stage” are displayed in a superimposed manner.

An operation of the display control device 1 according to the first embodiment will be described.

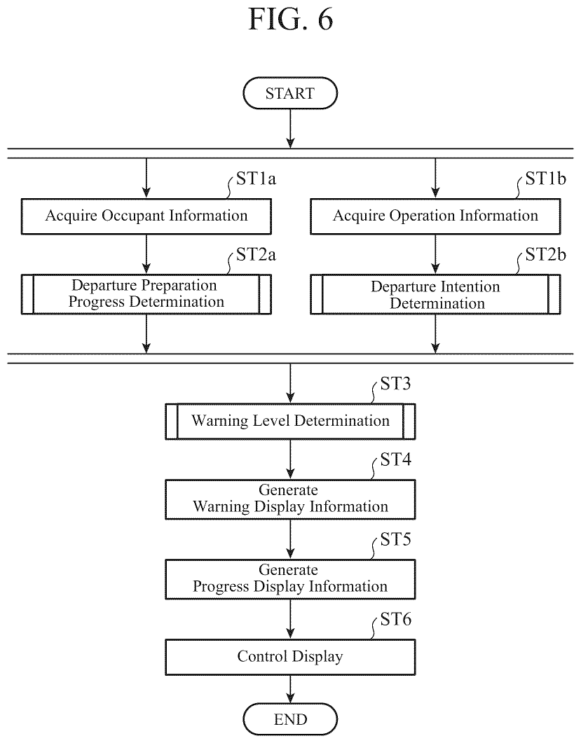

FIG. 6 is a flowchart for explaining the operation of the display control device 1 according to the first embodiment.

For example, the display control device 1 repeats the operation as illustrated in the flowchart of FIG. 6 while a power supply of the vehicle is turned on.

The occupant information acquiring unit 11 acquires occupant information on the basis of first sensor information output from the first sensor 20 (step ST1a).

Specifically, the seating information acquiring unit 111 acquires seating information. Further, the seat belt wearing information acquiring unit 112 acquires seat belt wearing information. Furthermore, the posture information acquiring unit 113 acquires posture information.

The occupant information acquiring unit 11 outputs the occupant information including the seating information acquired by the seating information acquiring unit 111, the seat belt wearing information acquired by the seat belt wearing information acquiring unit 112, and the posture information acquired by the posture information acquiring unit 113 to the departure preparation progress determining unit 13.

The operation information acquiring unit 12 acquires operation information on the basis of second sensor information output from the second sensor 30 (step ST1b). Specifically, the shift operation information acquiring unit 121 acquires shift operation information. Further, the parking brake operation information acquiring unit 122 acquires parking brake operation information. Furthermore, the pedal operation information acquiring unit 123 acquires pedal operation information.

The operation information acquiring unit 12 outputs the operation information including the shift operation information acquired by the shift operation information acquiring unit 121, the parking brake operation information acquired by the parking brake operation information acquiring unit 122, and the pedal operation information acquired by the pedal operation information acquiring unit 123 to the departure intention determining unit 14.

On the basis of the occupant information acquired by the occupant information acquiring unit 11 in step ST1a, the departure preparation progress determining unit 13 determines progress of preparation by a passenger for departure of the vehicle (step ST2a).

The departure preparation progress determining unit 13 outputs departure preparation progress information regarding the determined progress of preparation by the passenger to the warning level determining unit 15 and the progress display information generating unit 17.

On the basis of the operation information acquired by the operation information acquiring unit 12 in step ST1b, the departure intention determining unit 14 determines intention to cause the vehicle to depart by the driver (step ST2b).

The departure intention determining unit 14 outputs departure intention information regarding the determined intention to depart by the driver to the warning level determining unit 15.

On the basis of the progress of preparation by the passenger determined by the departure preparation progress determining unit 13 in step ST2a and the intention to cause the vehicle to depart by the driver determined by the departure intention determining unit 14 in step ST2b, the warning level determining unit 15 determines a warning level for warning the driver of severity of an unexpected situation that the vehicle or the occupant may fall into when the vehicle departs (step ST3).

The warning level determining unit 15 outputs a level determination result to the warning display information generating unit 16.

On the basis of the level determination result output from the warning level determining unit 15 in step ST3, the warning display information generating unit 16 generates warning display information for causing to perform display corresponding to the warning level determined by the warning level determining unit 15 for the driver (step ST4).

The warning display information generating unit 16 outputs the generated warning display information to the display control unit 18 in association with the information indicating the intention to depart by the driver and the information indicating the progress of preparation by the passenger.

The progress display information generating unit 17 generates progress display information for causing to perform display corresponding to the progress state of preparation by the passenger on the basis of the progress of preparation by the passenger determined by the departure preparation progress determining unit 13 in step ST5 (step ST2a).

The progress display information generating unit 17 outputs the generated progress display information to the display control unit 18 in association with the information indicating the progress of preparation by the passenger.

The display control unit 18 causes the display device 40 to perform display based on the warning display information generated by the warning display information generating unit 16 in step ST4 and to perform display based on the progress display information generated by the progress display information generating unit 17 in step ST5 (step ST6).

In the operation of the display control device 1 illustrated in the flowchart of FIG. 6, processing is performed in the order of step ST3, step ST4, and step ST5, but this is merely an example. The order of processing in steps ST3 to ST4 and processing in step ST5 may be reversed, or the processing in steps ST3 to ST4 and the processing in step ST5 may be performed in parallel.

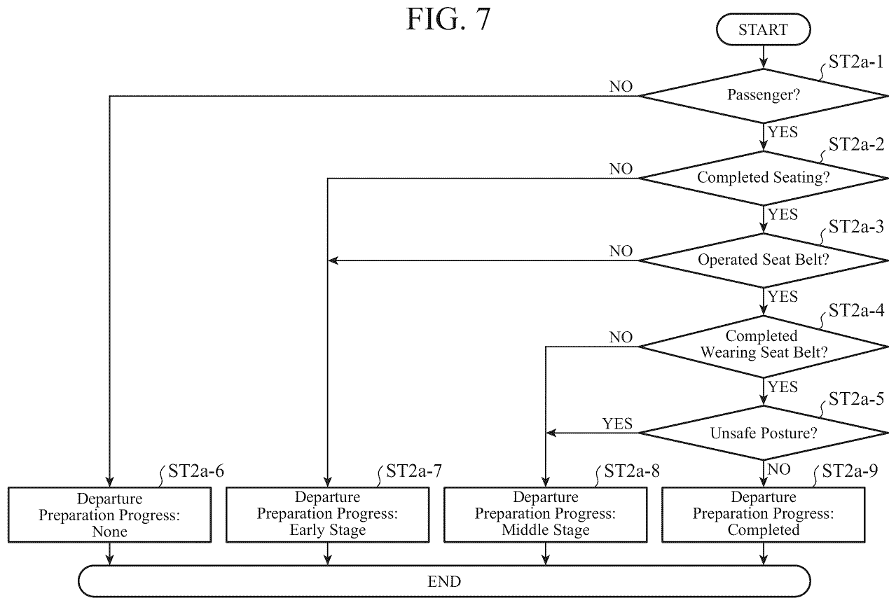

FIG. 7 is a flowchart for explaining details of an example of processing in step ST2a in FIG. 6 by the departure preparation progress determining unit 13.

Note that the processing illustrated in the flowchart of FIG. 7 is processing in a case where the departure preparation progress determining unit 13 determines the progress of preparation by the passenger in four stages of “none”, “early stage”, “middle stage”, and “completed”.

First, the departure preparation progress determining unit 13 determines presence or absence of a passenger on the basis of the occupant information (step ST2a-1).

If it is determined in step ST2a-1 that there is a passenger (if “YES” in step ST2a-1), the departure preparation progress determining unit 13 determines whether or not the passenger has completed seating (step ST2a-2).

If it is determined in step ST2a-2 that the passenger has completed seating (if “YES” in step ST2a-2), the departure preparation progress determining unit 13 determines whether or not the passenger has operated the seat belt (step ST2a-3).

If it is determined in step ST2a-3 that the passenger has operated the seat belt (if “YES” in step ST2a-3), the departure preparation progress determining unit 13 determines whether or not the passenger has completed wearing of the seat belt (step ST2a-4).

If it is determined in step ST2a-4 that the passenger has completed wearing of the seat belt (if “YES” in step ST2a-4), the departure preparation progress determining unit 13 determines presence or absence of unsafe posture of the passenger (step ST2a-5).

If it is determined in step ST2a-5 that there is no unsafe posture of the passenger (if “NO” in step ST2a-5), the departure preparation progress determining unit 13 determines that the progress of preparation by the passenger is “3: completed” (step ST2a-9).

If it is determined in step ST2a-4 that the passenger has not completed wearing of the seat belt (if “NO” in step ST2a-4) or if it is determined in step ST2a-5 that there is unsafe posture of the passenger (if “YES” in step ST2a-5), the departure preparation progress determining unit 13 determines that the progress of preparation by the passenger is “2: middle stage” (step ST2a-8).

If it is determined in step ST2a-2 that the passenger has not completed seating (if “NO” in step ST2a-2), or if it is determined in step ST2a-3 that the passenger has not operated the seat belt (if “NO” in step ST2a-3), the departure preparation progress determining unit 13 determines that the progress of preparation by the passenger is “1: early stage” (step ST2a-7).

If it is determined in step ST2a-1 that there is no passenger (if “NO” in step ST2a-1), the departure preparation progress determining unit 13 determines that the progress of preparation by the passenger is “0: none” (step ST2a-6).

Then, the departure preparation progress determining unit 13 outputs the departure preparation progress information to the warning level determining unit 15 and the progress display information generating unit 17.

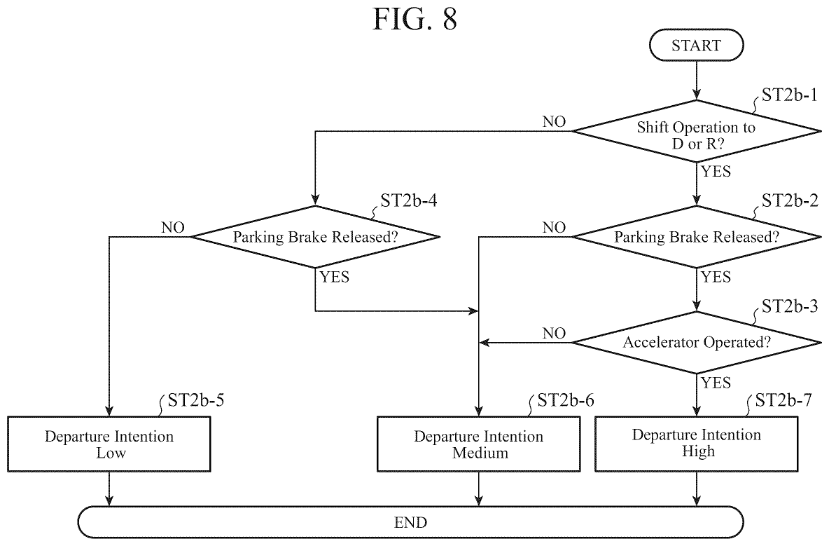

FIG. 8 is a flowchart for explaining details of processing in step ST2b in FIG. 6 by the departure intention determining unit 14.

Note that the processing illustrated in the flowchart of FIG. 8 is processing in a case where the departure intention determining unit 14 determines the intention to depart by the driver in three stages of “low”, “medium”, or “high”.

First, the departure intention determining unit 14 determines whether or not a shift operation to set the shift D or the shift R has been performed on the basis of the operation information (step ST2b-1).

If it is determined in step ST2b-1 that the shift operation to set the shift D or the shift R has been performed (if “YES” in step ST2b-1), the departure intention determining unit 14 determines whether or not an operation to release the parking brake has been performed (step ST2b-2).

If it is determined in step ST2b-2 that the operation to release the parking brake has been performed (if “YES” in step ST2b-2), the departure intention determining unit 14 determines whether or not an accelerator operation has been performed on the basis of the operation information (step ST2b-3).

If it is determined in step ST2b-3 that the accelerator operation has been performed (if “YES” in step ST2b-3), the departure intention determining unit 14 determines that the intention to depart by the driver is “high” (step ST2b-7).

On the other hand, if it is determined in step ST2b-1 that the shift operation to set the shift D or the shift R has not been performed (“NO” in step ST2b-1), in other words, if it is determined that the shift position remains at the shift P, the departure intention determining unit 14 determines whether or not an operation to release the parking brake has been performed (step ST2b-4).

If it is determined in step ST2b-4 that the operation to release the parking brake has been performed (if “YES” in step ST2b-4), if it is determined in step ST2b-2 that the operation to release the parking brake has not been performed (if “NO” in step ST2b-2), or if it is determined in step ST2b-3 that the accelerator operation has not been performed (if “NO” in step ST2b-3), the departure intention determining unit 14 determines that the intention to depart by the driver is “medium” (step ST2b-6).

If it is determined in step ST2b-4 that the operation to release the parking brake has not been performed (if “NO” in step ST2b-4), the departure intention determining unit 14 determines that the intention to depart by the driver is “low” (step ST2b-5).

Then, the departure intention determining unit 14 outputs the departure intention information to the warning level determining unit 15.

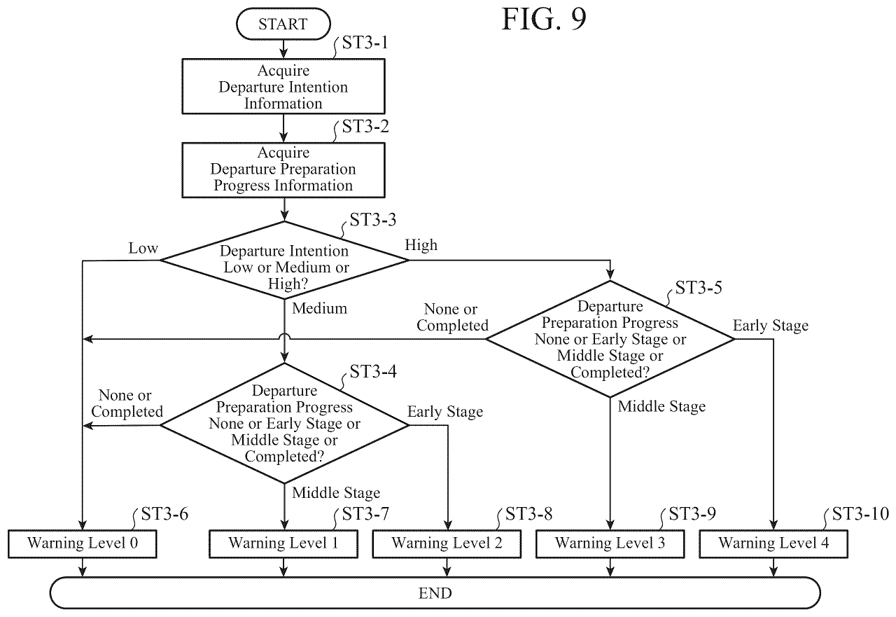

FIG. 9 is a flowchart for explaining details of an example of processing in step ST3 in FIG. 6 by the warning level determining unit 15.

Note that the processing illustrated in the flowchart of FIG. 9 is processing in a case where the warning level determining unit 15 determines warning levels of five levels “level 0” to “level 4” in accordance with the warning level determination condition, and the above-described (Condition A) to (Condition F) are set in the warning level determination condition.

The warning level determining unit 15 acquires the departure intention information output from the departure intention determining unit 14 in step ST2b of FIG. 6 (step ST3-1).

The warning level determining unit 15 acquires the departure preparation progress information output from the departure preparation progress determining unit 13 in step ST2a of FIG. 6 (step ST3-2).

On the basis of the departure intention information, the warning level determining unit 15 determines whether the intention to depart by the driver is “low”, “medium”, or “high” (step ST3-3).

If it is determined in step ST3-3 that the intention to depart by the driver is “high” (if “High” in step ST3-3), the warning level determining unit 15 determines whether the progress of preparation by the passenger is “0: none”, “1: early stage”, “2: middle stage”, or “3: completed” on the basis of the departure preparation progress information (step ST3-5).

If it is determined in step ST3-5 that the progress of preparation by the passenger is “1: early stage” (if “Early Stage” in step ST3-5), the warning level determining unit 15 determines the warning level as “level 4” (step ST3-10).

If it is determined in step ST3-5 that the progress of preparation by the passenger is “2: middle stage” (if “Middle Stage” in step ST3-5), the warning level determining unit 15 determines the warning level as “level 3” (step ST3-9).

If it is determined in step ST3-3 that the intention to depart by the driver is “medium” (if “Medium” in step ST3-3), the warning level determining unit 15 determines whether the progress of preparation by the passenger is “0: none”, “1: early stage”, “2: middle stage”, or “3: completed” on the basis of the departure preparation progress information (step ST3-4).

If it is determined in step ST3-4 that the progress of preparation by the passenger is “1: early stage” (if “Early Stage” in step ST3-4), the warning level determining unit 15 determines the warning level as “level 2” (step ST3-8).

If it is determined in step ST3-4 that the progress of preparation by the passenger is “2: middle stage” (if “Middle Stage” in step ST3-4), the warning level determining unit 15 determines the warning level as “level 1” (step ST3-7).

If it is determined in step ST3-3 that the intention to depart by the driver is “low” (if “Low” in step ST3-3), if it is determined in step ST3-5 that the progress of preparation by the passenger is “0: none” or “3: completed” (if “None” or “Completed” in step ST3-5), or if it is determined in step ST3-4 that the progress of preparation by the passenger is “0: none” or “3: completed” (if “None” or “Completed” in step ST3-4), the warning level determining unit 15 determines the warning level as “level 0” (step ST3-6).

Then, the warning level determining unit 15 outputs a level determination result to the warning display information generating unit 16.

Note that, in the flowchart of FIG. 9, the processing is performed in the order of step ST3-1 and step ST3-2, but this is merely an example. The order of the processing in step ST3-1 and the processing in step ST3-2 may be reversed, or the processing in step ST3-1 and the processing in step ST3-2 may be performed in parallel.

As described above, by causing the display device 40 to perform display based on the warning display information, when the driver operates the vehicle to cause the vehicle to depart, the display control device 1 can warn the driver of severity of an unexpected situation that may occur in different levels. By simply checking the display device 40, the driver can grasp the severity of the unexpected situation that may occur, and can take some measures corresponding to the severity of the unexpected situation that may occur.

At this time, the display control device 1 can notify the driver of the progress of preparation by the passenger by causing to perform display based on the progress display information together. By grasping the progress of preparation by the passenger, the driver can easily grasp what kind of measures to be taken against the passenger.

For example, by causing to perform display corresponding to the warning level “level 4” (for example, Da in FIG. 4), the display control device 1 allows the driver to grasp that there is a high possibility that a serious unexpected situation will occur and that it is necessary to take measures to avoid the unexpected situation, such as immediately stopping the operation of the vehicle for departure or returning the operation. For example, the driver immediately stops the operation of the vehicle for departure or operates the vehicle to return the operation. At this time, since the display control device 1 causes to perform display indicating that the progress of preparation by the passenger is “early stage”, for example, it is possible for the driver to grasp at a glance that the preparation by the passenger has hardly progressed although the operation of the vehicle has progressed to a point where the vehicle can depart soon. The driver can speak to the passenger to help him or her prepare, such as “Do you need any help?”.

In addition, for example, by causing to perform display corresponding to the warning level “level 3” (for example, Db in FIG. 4), the display control device 1 can warn the driver that there is a possibility that a serious unexpected situation will occur and that it is necessary to eliminate the possibility that the unexpected situation will occur. At this time, since the display control device 1 causes to perform display indicating that the progress of preparation by the passenger is “middle stage”, for example, it is possible for the driver to grasp at a glance that the operation of the vehicle has progressed to a point where the vehicle can depart soon but the preparation by the passenger has not been completed and that there is no problem in causing the vehicle to depart when the preparation by the passenger who has progressed to one step before completion is completed. The driver can speak to the passenger to inform the departure and prompt him or her to complete preparation for departure, such as “Can we leave? Are you OK?”.

In addition, for example, by causing to perform display corresponding to the warning level “level 2” (for example, Dd in FIG. 4), the display control device 1 can warn the driver that there is a low possibility that a serious unexpected situation will occur but that it is necessary to pay attention to a state of the passenger. At this time, since the display control device 1 causes to perform display indicating that the progress of preparation by the passenger is “early stage”, for example, it is possible for the driver to grasp at a glance that the progress of preparation by the passenger is slow with respect to the progress of operation of the vehicle. The driver can speak to the passenger to check a state of the passenger, such as “Sit down quickly. Do you have your seat belt on?”.

In addition, for example, by causing to perform display corresponding to the warning level “level 1” (for example, De in FIG. 4), the display control device 1 can warn the driver that there is little possibility that a serious unexpected situation will occur but that it is better to be aware of the state of the passenger. For example, the driver operates the vehicle for departure in consideration of allowing the passenger to depart comfortably. At this time, since the display control device 1 causes to perform display to notify that the progress of preparation by the passenger is “middle stage”, for example, it is possible for the driver to grasp at a glance that the preparation by the passenger is not completed but proceeds smoothly. The driver can speak to the passenger to prepare for the departure of the vehicle, such as “It seems all right to leave soon”.

When the warning level is “level 0”, the display control device 1 does not perform display corresponding to the warning level. That is, when the warning level is “level 0”, the display control device 1 does not warn the driver that there is a possibility of an unexpected situation. Since the warning is not issued, the driver can grasp that the vehicle or the occupant does not fall into an unexpected situation even if the vehicle departs or that an unexpected situation that may occur when the vehicle departs is not serious. At this time, the display control device 1 causes to perform display for notifying the progress of preparation by the passenger. When looking at the display for notifying the progress of preparation by the passenger, the driver can grasp that the preparation by the passenger is completed or that the preparation will be completed by the departure. The driver can use consciousness for other things without having to be conscious of the passenger.

In the conventional technique of notifying the state of wearing the seat belt by the passenger by displaying a certain expression as described above, it is not possible for the driver to grasp how serious an unexpected situation may occur when the driver causes the vehicle to depart by looking at the display. In the technique of notifying the state of the passenger by displaying the certain expression, for example, the driver may assume that the preparation by the passenger is proceeding smoothly and there is no problem in causing the vehicle to depart, in other words, the vehicle will not be brought into an unexpected situation even if it departs, and proceed with the operation for departure and feel an abnormality when stepping on the accelerator. The driver checks the passenger at that time, and then notices that the passenger has forgotten to make preparations or that some kind of trouble has occurred in the passenger.

As described above, conventionally, it has not been possible to notify the driver of a degree of severity of the unexpected situation that may occur when the driver causes the vehicle to depart. Therefore, in order for the driver to grasp the degree of severity of the unexpected situation that may occur when the driver causes the vehicle to depart, the driver has to check how much the preparation for the departure of the vehicle by the passenger has progressed by asking the passenger or by changing posture and looking at the passenger.

On the other hand, the display control device 1 according to the first embodiment can warn the driver that an unexpected situation may occur when the driver causes the vehicle to depart in such a manner that severity of the unexpected situation that may occur can be recognized, in other words, importance of the warning can be recognized by generating warning display information for performing display corresponding to a determined warning level and causing the display device 40 to display the warning display information. Recognizing the importance of the warning reduces time and effort for the driver to check the state of the passenger in detail. Further, the display control device 1 changes a display content as the intention to depart by the driver increases or as the preparation for departure by the passenger progresses. For example, the driver can grasp that the importance of the warning has changed due to the warning that changes while the driver advances the operation for departure, and can grasp measures in accordance with a current state to be performed.

For example, it is assumed that the driver stops the operation for departure and waits because the display corresponding to the warning level “level 3” is performed. Thereafter, when the passenger smoothly prepares for departure, the display changes in order of the display corresponding to “level 2”, the display corresponding to “level 1”, and the display corresponding to “level 0”. By looking at the changing display, the driver can grasp that the passenger is preparing for departure and that the state is approaching a state in which there is no problem even if the driver causes the vehicle to depart.

If the display corresponding to the warning level “level 3” remains even after a while, the driver grasps that a state in which a serious unexpected situation may occur when the driver continuously causes the vehicle to depart. In this case, the driver can check the state in detail in order to eliminate a state in which a serious unexpected situation may occur when the driver causes the vehicle to depart, such as prompting the passenger to make preparations, and to cause the vehicle to depart without any problem.

Note that, as described above, in the first embodiment, it is assumed that, when the occupant gets into the vehicle and the driver operates the vehicle to cause the vehicle to depart, the display control device 1 causes the display device to display a display for warning the driver that an unexpected situation may occur when the vehicle departs. Not limited to this, the display control device 1, for example, even when the vehicle is traveling, in other words, even when the vehicle departs, in a case where the passenger deviates from the state in which the passenger has completed seating, the state in which the passenger has completed wearing of the seat belt, or the state in which there is no unsafe posture, gives the driver a level-divided warning of severity of an unexpected situation that may occur due to the departure of the vehicle, which is similar to the case when the driver causes the vehicle to depart by always executing the operation as illustrated in the flowchart of FIG. 6 while the power supply of the vehicle is turned on. As a result, the display control device 1 can also help the driver to notice that the warning is to be taken to avoid an unexpected situation.

In the first embodiment described above, the progress display information generating unit 17 may generate progress display information for displaying progress of preparation by the passenger in animation that changes with a lapse of time depending on the progress of preparation by the passenger.

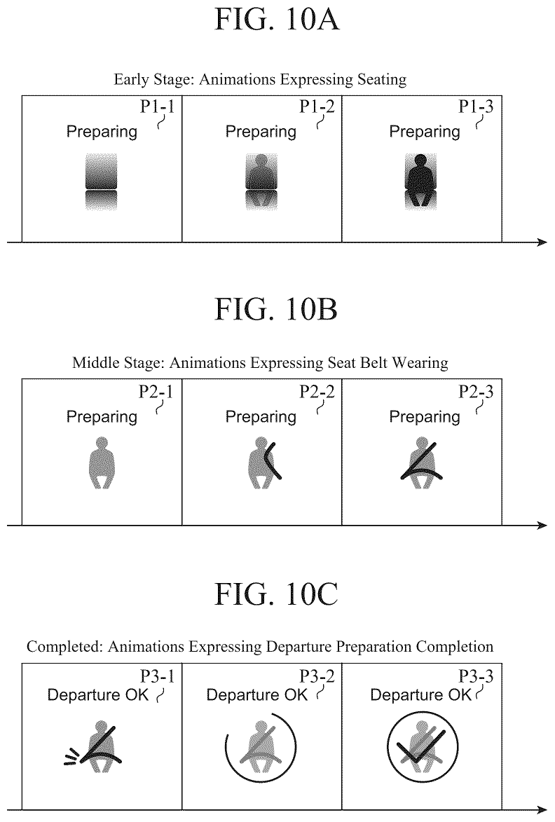

FIGS. 10A, 10B, and 10C are diagrams for explaining the progress display information generated by the progress display information generating unit 17 in the first embodiment for displaying progress of preparation by a passenger in animation that changes with a lapse of time.

For example, when the progress of preparation by the passenger is “1: early stage”, the progress display information generating unit 17 may generate progress display information for causing the display device 40 to display a screen on which an icon indicating a seat (see P1-1), an icon indicating the seat and a person displayed lightly (see P1-2), and an icon indicating the seat and the person displayed darkly (see P1-3) are repeatedly displayed in animation, as illustrated in FIG. 10A.

For example, when the progress of preparation by the passenger is “2: middle stage”, the progress display information generating unit 17 may generate progress display information for causing the display device 40 to display a screen on which an icon indicating a person (see P2-1), an icon indicating the person who has pulled out the seat belt up to a shoulder (see P2-2), and an icon indicating the person who has pulled out the seat belt up to a waist (see P2-3) are repeatedly displayed in animation, as illustrated in FIG. 10B.

For example, when the progress of preparation by the passenger is “3: completed”, the progress display information generating unit 17 may generate progress display information for causing the display device 40 to display a screen on which an icon indicating a person who has completed wearing the seat belt (see P3-1), an icon indicating a state in which a check mark is partially superimposed on the person who has completed wearing the seat belt (see P3-2), and an icon indicating a state in which the check mark is completely superimposed on the person who has completed wearing the seat belt (see P3-3) are repeatedly displayed in animation, as illustrated in FIG. 10C.

Note that, in FIGS. 10A, 10B, and 10C, a square surrounding the message and the icon is illustrated for convenience, but the square is not displayed on the display device 40.

In addition, in the above first embodiment, in the display control device 1, the display control unit 18 causes the display device 40 to perform display based on the warning display information generated by the warning display information generating unit 16 and to perform display based on the progress display information generated by the progress display information generating unit 17, but this is merely an example.

The display control unit 18 is only required to cause the display device 40 to perform at least display based on the warning display information generated by the warning display information generating unit 16. That is, the display control unit 18 does not need to perform display based on the progress display information generated by the progress display information generating unit 17. When the display control unit 18 does not cause to perform the display based on the progress display information, the display control device 1 can be configured not to include the progress display information generating unit 17. In this case, the display control device 1 can omit the processing of step ST5 for the operation of the display control device 1 described with reference to the flowchart in FIG. 6.

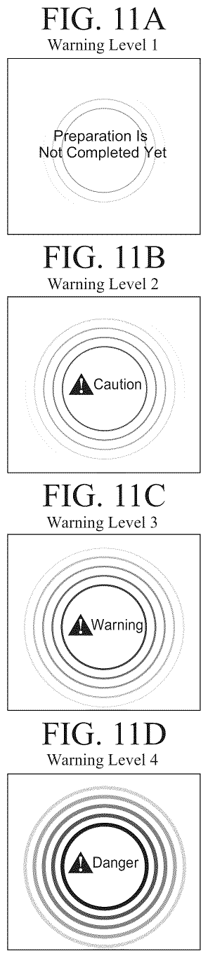

Here, FIGS. 11A, 11B, 11C, and 11D are diagrams for explaining screen examples of the display device 40 in a case where the display control unit 18 causes the display device 40 to display only a display based on the warning display information in the first embodiment.

Since it is not necessary to display a message or an icon based on the warning display information and a message or an icon based on the progress display information in a superimposed manner, for example, as illustrated in FIGS. 11A, 11B, 11C, and 11D, the display control unit 18 may perform display control in such a manner that a message “preparation is not completed yet”, “caution”, “warning”, or “danger” is displayed at the center of a circle icon.

In FIGS. 11A, 11B, 11C, and 11D, a square surrounding the message and the icon is illustrated for convenience, but the square is not displayed on the display device 40.

Note that, in a case where the display control unit 18 causes the display device 40 to display both the message or the icon based on the warning display information and the message or the icon based on the progress display information, it is not necessary to display the message or the icon based on the warning display information and the message or the icon based on the progress display information in a superimposed manner. For example, the display control unit 18 may cause the display device 40 to display the message or the icon based on the warning display information and the message or the icon based on the progress display information side by side.

Further, in the above first embodiment, the departure preparation progress determining unit 13 determines the progress of preparation by the passenger by using the seating information, the seat belt wearing information, and the posture information. However, this is merely an example.

For example, the departure preparation progress determining unit 13 may determine the progress of preparation by the passenger by using any one or two of the seating information, the seat belt wearing information, and the posture information.

In a case where the departure preparation progress determining unit 13 does not use the seating information for determining the progress of preparation by the passenger, the display control device 1 can be configured not to include the seating information acquiring unit 111. In this case, the departure preparation progress determining unit 13 can omit the processing of steps ST2a-1 to ST2a-2 in the operation described with reference to the flowchart of FIG. 7.

In a case where the departure preparation progress determining unit 13 does not use the seat belt wearing information to determine the progress of preparation by the passenger, the display control device 1 can be configured not to include the seat belt wearing information acquiring unit 112. In this case, the departure preparation progress determining unit 13 can omit the processing of steps ST2a-3 to ST2a-4 in the operation described with reference to the flowchart of FIG. 7.

In a case where the departure preparation progress determining unit 13 does not use the posture information for determining the progress of preparation by the passenger, the display control device 1 can be configured not to include the posture information acquiring unit 113. In this case, the departure preparation progress determining unit 13 can omit the processing of step ST2a-5 in the operation described with reference to the flowchart of FIG. 7.

Further, in the above first embodiment, the departure preparation progress determining unit 13 may determine the progress of preparation by the passenger by using information other than the seating information, the seat belt wearing information, and the posture information.

For example, the departure preparation progress determining unit 13 may determine the progress of preparation by the passenger on the basis of a behavior other than the unsafe posture of the passenger (for example, whether or not he or she is calm, or whether or not he or she is performing an action irrelevant to departure). In this case, for example, the occupant information acquiring unit 11 detects the behavior other than the unsafe posture of the passenger, and outputs it to the departure preparation progress determining unit 13 as the occupant information.

Further, for example, the departure preparation progress determining unit 13 may determine the progress of preparation by the passenger on the basis of a direction of a line of sight of the passenger (for example, whether or not he or she is facing the front). In this case, for example, the occupant information acquiring unit 11 detects the direction of the line of sight of the passenger and outputs it to the departure preparation progress determining unit 13 as the occupant information.

Furthermore, for example, the departure preparation progress determining unit 13 may determine the progress of preparation by the passenger on the basis of expression of the passenger. In this case, for example, the occupant information acquiring unit 11 detects the expression of the passenger and outputs it to the departure preparation progress determining unit 13 as the occupant information.

Further, in the above first embodiment, the departure intention determining unit 14 determines the intention to depart by the driver by using the shift operation information, the parking brake operation information, and the pedal operation information. However, this is merely an example.

For example, the departure intention determining unit 14 may determine the intention to depart by the driver by using any one or two of the shift operation information, the parking brake operation information, and the pedal operation information.

When the departure intention determining unit 14 does not use the shift operation information to determine the intention to depart by the driver, the display control device 1 can be configured not to include the shift operation information acquiring unit 121. In this case, the departure intention determining unit 14 can omit the processing of step ST2b-1 in the operation described with reference to the flowchart of FIG. 8.

When the departure intention determining unit 14 does not use the parking brake operation information to determine the intention to depart by the driver, the display control device 1 can be configured not to include the parking brake operation information acquiring unit 122. In this case, the departure intention determining unit 14 can omit the processing of steps ST2b-2 and ST2b-4 in the operation described with reference to the flowchart of FIG. 8.

When the departure intention determining unit 14 does not use the pedal operation information to determine the intention to depart by the driver, the display control device 1 can be configured not to include the pedal operation information acquiring unit 123. In this case, the departure intention determining unit 14 can omit the processing of step ST2b-3 in the operation described with reference to the flowchart of FIG. 8.

Further, in the above first embodiment, the departure intention determining unit 14 may determine the intention to depart by the driver by using information other than the shift operation information, the parking brake operation information, and the pedal operation information.

For example, the departure intention determining unit 14 may determine the intention to depart by the driver on the basis of information on whether or not the driver is holding the steering wheel. In this case, for example, the operation information acquiring unit 12 detects whether or not the driver is holding the steering wheel, and outputs it to the departure intention determining unit 14 as the operation information.

Further, in the above first embodiment, the departure preparation progress determining unit 13 determines the progress of preparation by the passenger for the departure of the vehicle in four stages of “0: none”, “1: early stage”, “2: middle stage”, and “3: completed”. However, this is merely an example. The progress of preparation by the passenger for the departure of the vehicle determined by the departure preparation progress determining unit 13 may be set to two stages, three stages, or five or more stages. The stage can be set by an administrator or the like according to the needs on the basis of an operation assumed to be performed in stages as preparation for departure when the passenger goes out in the vehicle.

In addition, in the above first embodiment, the departure intention determining unit 14 determines the intention to cause the vehicle to depart by the driver in three stages of “low”, “medium”, or “high”, but this is merely an example. The intention to cause the vehicle to depart by the driver determined by the departure intention determining unit 14 may be set to two stages or four or more stages. The stage can be set by an administrator or the like according to the needs on the basis of an operation assumed to be performed in stages when the driver causes the vehicle to depart.

Further, in the above first embodiment, the warning level determined by the warning level determining unit 15 is set to five stages of “level 0” to “level 4”, but this is merely an example. The stage of the warning level can be set by an administrator or the like according to the needs.

Further, in the above first embodiment, it is assumed that the passenger sits on the rear seat, but this is merely an example. For example, the passenger may sit on a passenger seat.

Further, in the first embodiment, the number of passengers is one, but this is merely an example. For example, there may be a plurality of passengers. In a case where there is a plurality of passengers, in the display control device 1, the departure preparation progress determining unit 13 may set an average of progress of preparation by the plurality of passengers as the progress of preparation by the passengers, or may set the slowest progress (that is, progress represented by the smallest numerical value) among the progress of preparation by the plurality of passengers as the progress of preparation by the passengers. For example, when there are two passengers, and the progress of preparation by one of the passengers is “1: early stage” and the progress of preparation by another passenger is “3: completed”, the departure preparation progress determining unit 13 may set “2: middle stage” as an average of the progress of preparation by the two passengers.

In addition, for example, the progress display information generating unit 17 may generate progress display information of each of the plurality of passengers, and the display control unit 18 may cause the display device 40 to perform display based on the progress display information of each of the plurality of passengers. For example, the display control unit 18 displays a seat in the vehicle interior, associates the displayed seat with a seat on which the passenger is seated or about to be seated, and causes to perform display based on the progress display information of each of the plurality of passengers. By checking the display device 40, the driver can intuitively grasp how far the passenger present in any seat can prepare for departure.

Further, in the above first embodiment, the display device 40 to be displayed by the display control device 1 is assumed to be one display device 40 provided at a position visually recognizable by the driver gazing ahead of the vehicle without largely moving the line of sight. However, this is merely an example. For example, the display device 40 to be displayed by the display control device 1 may be a display device 40 provided at a position visually recognizable by a passenger on a rear seat, such as a back surface of a seat of a front seat, in addition to the display device 40 provided at the position visually recognizable by the driver gazing ahead of the vehicle without largely moving the line of sight. In this case, for example, the display control device 1 can notify the passenger on the rear seat of an intention to depart by the driver and an unexpected situation that can occur when the driver causes the vehicle to depart. As a result, for example, the passenger can voluntarily make preparations for departure earlier without waiting for an instruction from the driver, convey a specific request such as instructing the driver to wait for departure, or behave to avoid an unexpected situation by himself or herself.

In the above first embodiment, the display control device 1 is an in-vehicle device mounted on a vehicle, and the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18 are provided in the in-vehicle device. Not limited to this, some of the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18 may be included in the in-vehicle device of the vehicle, and others may be included in a server connected to the in-vehicle device via a network. Further, the server may include all of the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18.

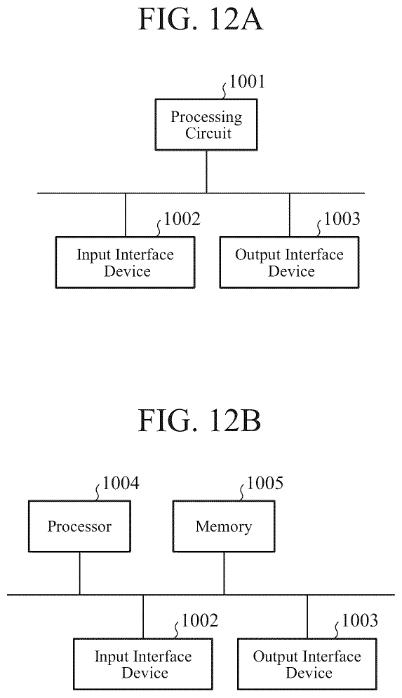

FIGS. 12A and 12B are diagrams illustrating an example of a hardware configuration of the display control device 1 according to the first embodiment.

In the first embodiment, functions of the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18 are implemented by a processing circuit 1001. That is, the display control device 1 includes the processing circuit 1001 for performing control to display an unexpected situation to the driver in a display form in which a degree of severity of the unexpected situation can be recognized in a case where the vehicle or the occupant may fall into the unexpected situation when the vehicle departs.

The processing circuit 1001 may be dedicated hardware as illustrated in FIG. 12A, or may be a processor 1004 that executes a program stored in a memory as illustrated in FIG. 12B.

When the processing circuit 1001 is dedicated hardware, the processing circuit 1001 corresponds to, for example, a single circuit, a composite circuit, a programmed processor, a parallel programmed processor, an application specific integrated circuit (ASIC), a field-programmable gate array (FPGA), or a combination thereof.

When the processing circuit is the processor 1004, the functions of the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18 are implemented by software, firmware, or a combination of software and firmware. The software or firmware is described as a program and stored in a memory 1005. The processor 1004 reads and executes the program stored in the memory 1005, thereby executing the functions of the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18. That is, the display control device 1 includes the memory 1005 for storing a program that results in execution of steps ST1a, ST1b to ST6 in FIG. 6 described above when executed by the processor 1004. Further, it can also be said that the program stored in the memory 1005 causes a computer to execute a processing procedure or method performed by the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18. Here, the memory 1005 corresponds to, for example, a nonvolatile or volatile semiconductor memory such as a RAM, a read only memory (ROM), a flash memory, an erasable programmable read only memory (EPROM), or an electrically erasable programmable read-only memory (EEPROM), a magnetic disk, a flexible disk, an optical disk, a compact disk, a mini disk, a digital versatile disc (DVD), or the like.

Note that the functions of the occupant information acquiring unit 11, the operation information acquiring unit 12, the departure preparation progress determining unit 13, the departure intention determining unit 14, the warning level determining unit 15, the warning display information generating unit 16, the progress display information generating unit 17, and the display control unit 18 may be partially implemented by dedicated hardware and partially implemented by software or firmware. For example, the functions of the occupant information acquiring unit 11 and the operation information acquiring unit 12 can be implemented by the processing circuit 1001 as dedicated hardware, and the functions of the departure preparation progress determining unit 13, the departure intention determining unit 14, the warning level determining unit 15, the warning display information generating unit 16, the progress display information generating unit 17, and the display control unit 18 can be implemented by the processor 1004 reading and executing the program stored in the memory 1005.

In addition, the display control device 1 includes an input interface device 1002 and an output interface device 1003 that perform wired communication or wireless communication with a device such as the first sensor 20, the second sensor 30, or the display device 40.

As described above, according to the first embodiment, a display control device 1 includes: an occupant information acquiring unit 11 to acquire occupant information regarding an occupant; an operation information acquiring unit 12 to acquire operation information regarding an operation of a vehicle by a driver of the vehicle; a departure preparation progress determining unit 13 to determine progress of preparation by a passenger for departure of the vehicle on the basis of the occupant information acquired by the occupant information acquiring unit 11; a departure intention determining unit 14 to determine intention to cause the vehicle to depart by the driver on the basis of the operation information acquired by the operation information acquiring unit 12; a warning level determining unit 15 to determine a level (warning level) for warning the driver of severity of an unexpected situation that the vehicle or the occupant is likely to fall into when the vehicle departs on the basis of the progress of preparation by the passenger determined by the departure preparation progress determining unit 13 and the intention to cause the vehicle to depart by the driver determined by the departure intention determining unit 14; a warning display information generating unit 16 to generate warning display information for causing to perform display corresponding to the level (warning level) determined by the warning level determining unit 15 for the driver; and a display control unit 18 to cause a display device 40 to perform display based on the warning display information generated by the warning display information generating unit 16. As a result, in a case where the vehicle or the occupant is likely to fall into an unexpected situation when the driver causes the vehicle to depart, the display control device 1 can warn the driver of this in a display form in which a degree of severity of the unexpected situation can be known. As a result, the driver can grasp the severity of the unexpected situation that may occur only by checking the display device 40, and can take some measures corresponding to the severity of the unexpected situation that may occur.

Further, in addition to the occupant information acquiring unit 11, the operation information acquiring unit 12, the departure preparation progress determining unit 13, the departure intention determining unit 14, the warning level determining unit 15, the warning display information generating unit 16, and the display control unit 18, the display control device 1 includes a progress display information generating unit 17 to generate progress display information for causing to perform display corresponding to the progress of preparation by the passenger on the basis of the progress of preparation by the passenger determined by the departure preparation progress determining unit 13, and the display control unit 18 is configured to cause the display device 40 to perform display based on the warning display information generated by the warning display information generating unit 16 and to perform display based on the progress display information generated by the progress display information generating unit 17. As a result, the display control device 1 can notify the driver of the progress of preparation by the passenger. By checking the display device 40, the driver can grasp the progress of preparation by the passenger, and can easily grasp what kind of measures should be taken for the passenger.

In addition, in the display control device 1, the progress display information generating unit 17 may generate progress display information for displaying the progress of preparation by the passenger in animation that changes with a lapse of time depending on the progress of preparation by the passenger. As a result, the display control device 1 can notify the driver of the progress of preparation by the passenger. The driver can grasp the progress of preparation by the passenger by checking the display device 40.

It is to be noted that any constituent element in the embodiment can be modified or any constituent element in the embodiment can be omitted.

### INDUSTRIAL APPLICABILITY

In the display control device according to the present disclosure, in a case where there is a possibility that a vehicle or an occupant falls into an unexpected situation when the driver causes the vehicle to depart, a driver can be warned of this in a display form in which a degree of severity of the unexpected situation can be recognized.

### REFERENCE SIGNS LIST

1: display control device, 11: occupant information acquiring unit, 111: seating information acquiring unit, 112: seat belt wearing information acquiring unit, 113: posture information acquiring unit, 12: operation information acquiring unit, 121: shift operation information acquiring unit, 122: parking brake operation information acquiring unit, 123: pedal operation information acquiring unit, 13: departure preparation progress determining unit, 14: departure intention determining unit, 15: warning level determining unit, 16: warning display information generating unit, 17: progress display information generating unit, 18: display control unit, 20: first sensor, 30: second sensor, 40: display device, 1001: processing circuit, 1002: input interface device, 1003: output interface device, 1004: processor, 1005: memory

1. A display control device comprising:
processing circuitry configured to
acquire occupant information regarding an occupant;
acquire operation information regarding an operation of a vehicle by a driver of the vehicle;
determine progress of preparation by a passenger for departure of the vehicle on a basis of the acquired occupant information;
determine intention to cause the vehicle to depart by the driver on a basis of the acquired operation information;
determine a plurality of levels for warning the driver of severity of an unexpected situation that the vehicle or the occupant is likely to fall into when the vehicle departs, the plurality of levels being set by a combination of the progress of preparation by the passenger and the intention to cause the vehicle to depart by the driver, on a basis of the determined progress of preparation by the passenger and the determined intention to cause the vehicle to depart by the driver;
generate warning display information for causing a display device to perform a plurality of displays with different types corresponding to the plurality of levels having been determined for the driver; and
cause the display device to display based on the generated warning display information.

2. The display control device according to claim 1, wherein
the processing circuitry is further configured to
generate the warning display information in such a way that the display is emphasized as the determined level is higher.

3. The display control device according to claim 1, wherein
the processing circuitry is further configured to
generate the warning display information for causing the display device to display an icon or a message corresponding to the determined level.

4. The display control device according to claim 1,
wherein the processing circuitry is further configured to
generate progress display information for causing the display device to display corresponding to the progress of preparation by the passenger on a basis of the determined progress of preparation by the passenger, wherein
the processing circuitry causes the display device to display based on the generated warning display information and to display based on the generated progress display information.

5. The display control device according to claim 4, wherein
the processing circuitry is further configured to
generate the progress display information for displaying the progress of preparation by the passenger in animation that changes with a lapse of time depending on the progress of preparation by the passenger.

6. A display control method comprising:
acquiring occupant information regarding an occupant;
acquiring operation information regarding an operation of a vehicle by a driver of the vehicle;
determining progress of preparation by a passenger for departure of the vehicle on a basis of the acquired occupant information;
determining intention to cause the vehicle to depart by the driver on a basis of the acquired operation information;
determining a plurality of levels for warning the driver of severity of an unexpected situation that the vehicle or the occupant is likely to fall into when the vehicle departs, the plurality of levels being set by a combination of the progress of preparation by the passenger and the intention to cause the vehicle to depart by the driver, on a basis of the determined progress of preparation by the passenger and the determined intention to cause the vehicle to depart by the driver;
generating warning display information for causing a display device to perform a plurality of displays with different types corresponding to the plurality of levels having been determined for the driver; and
causing the display device to display based on the generated warning display information.
